(19) United States
(12) Patent Application Publication
(10) Pub. No.: US 2025/0181362 A1
(43) Pub. Date: Jun. 5, 2025

(54) FILE PROCESSING METHOD AND APPARATUS, ELECTRONIC DEVICE, AND STORAGE MEDIUM

(71) Applicant: Beijing Zitiao Network Technology Co., Ltd., Beijing (CN)

(72) Inventor: Huaiye Shen, Beijing (CN)

(21) Appl. No.: 18/962,723

(22) Filed: Nov. 27, 2024

(30) Foreign Application Priority Data
Dec. 1, 2023 (CN) 202311641166.7

(51) Int. Cl. G06F 9/445; G06F 40/205

(52) U.S. Cl. CPC G06F 9/44521; G06F 40/205

(57) ABSTRACT

Embodiments of the present disclosure provide a file processing method and apparatus, an electronic device, and a storage medium. The method includes: obtaining a functional logic file corresponding to a target function, and parsing the functional logic file to obtain a target object corresponding to the target function, where the target object includes at least one of a function object, a class object, a variable object, and a constant object; obtaining an original entry file corresponding to the target function and an object hierarchical relationship corresponding to the original entry file; and determining a target entry file corresponding to the target function based on the object hierarchical relationship, the target object, and the original entry file.

### CROSS-REFERENCE TO RELATED APPLICATION(S)

This application claims priority to Chinese Application No. 202311641166.7 filed on Dec. 1, 2023, the disclosure of which is incorporated herein by reference in its entirety.

### FIELD

Embodiments of the present disclosure relate to computer application technologies, and in particular, to a file processing method and apparatus, an electronic device, and a storage medium.

### BACKGROUND

With the development of computer technologies, software functions written based on computer programming languages are widely applied in various scenarios, for example, special effect props in special effect scenarios, and the like. Generally, computer programming languages themselves tend to have their own unique syntax restrictions and specifications, for example, regarding which functions are used for importing and exporting functional modules and which functional modules are imported and exported, and the like.

In the related art, in order to reduce development workload and ensure the normal use of functions, a default syntax of computer programming languages is often used, which makes it necessary for functions to be executed according to specific logic when they are executed. For example, when a functional module is imported, all functional modules in a function library need to be loaded, but the execution of the function may only be related to the loading of some functional modules in the function library. In this case, this method of full loading of functional modules may result in a long overall response time for the function and low response efficiency, and even cause lagging.

### SUMMARY

Embodiments of the present disclosure provide a file processing method and apparatus, an electronic device, and a storage medium to solve the technical problem of low functional response efficiency.

According to a first aspect, an embodiment of the present disclosure provides a file processing method. The method includes: obtaining a functional logic file corresponding to a target function, and parsing the functional logic file to obtain a target object corresponding to the target function, where the functional logic file is a script file including control logic for the target function; and the target object includes at least one of a function object, a class object, a variable object, and a constant object; obtaining an original entry file corresponding to the target function and an object hierarchical relationship corresponding to the original entry file, where the object hierarchical relationship is used to indicate an association relationship between each functional module in a function library corresponding to the target function and each functional object in the functional module; and pruning content in the original entry file based on the object hierarchical relationship and the target object to obtain the target entry file corresponding to the target function.

According to a second aspect, an embodiment of the present disclosure further provides a file processing apparatus. The apparatus includes: a functional logic parsing module configured to obtain a functional logic file corresponding to a target function, and parse the functional logic file to obtain a target object corresponding to the target function, where the functional logic file is a script file including control logic for the target function; and the target object includes at least one of a function object, a class object, a variable object, and a constant object; a hierarchical relationship obtaining module configured to obtain an original entry file corresponding to the target function and an object hierarchical relationship corresponding to the original entry file, where the object hierarchical relationship is used to indicate an association relationship between each functional module in a function library corresponding to the target function and each functional object in the functional module; and an entry file adjustment module configured to prune content in the original entry file based on the object hierarchical relationship and the target object to obtain the target entry file corresponding to the target function.

According to a third aspect, an embodiment of the present disclosure further provides an electronic device. The electronic device includes: one or more processors; and a storage apparatus configured to store one or more programs, where the one or more programs, when executed by the one or more processors, cause the one or more processors to implement the file processing method according to any one of the embodiments of the present disclosure.

According to a fourth aspect, an embodiment of the present disclosure further provides a storage medium including computer-executable instructions, where the computer-executable instructions, when executed by a computer processor, are configured to perform the file processing method according to any one of the embodiments of the present disclosure.

### BRIEF DESCRIPTION OF THE DRAWINGS

The foregoing and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a schematic flowchart of a file processing method according to an embodiment of the present disclosure;

FIG. 2 is a schematic flowchart of another file processing method according to an embodiment of the present disclosure;

FIG. 3 is a schematic diagram of a structure of a file processing apparatus according to an embodiment of the present disclosure; and

FIG. 4 is a schematic diagram of a structure of an electronic device according to an embodiment of the present disclosure.

### DETAILED DESCRIPTION OF EMBODIMENTS

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

It can be understood that the data involved in the technical solutions (including, but not limited to, the data itself and the access to or use of the data) shall comply with the requirements of corresponding laws, regulations, and relevant provisions.

FIG. 1 is a schematic flowchart of a file processing method according to an embodiment of the present disclosure. The embodiments of the present disclosure are applicable to a case of optimizing an entry file, and are especially applicable to a case in which a functional logic file is written using a javascript script and the reference of functional modules only supports the use of commonJS. The method may be executed by a file processing apparatus. The apparatus may be implemented in the form of software and/or hardware, and optionally, by an electronic device, which may be a mobile terminal, a PC, a server, etc.

As shown in FIG. 1, the method of this embodiment may specifically include the following steps.

At S110, a functional logic file corresponding to a target function is obtained, and the functional logic file is parsed to obtain a target object corresponding to the target function.

The target function is a function for which a target entry file corresponding thereto is to be generated. For example, the target function may be one or more functions implemented based on an application, for example, a special effect function implemented based on a special effect prop in a special effect application or a function implemented based on an integrated functional plug-in in other applications, and the like. Specifically, the target function is implemented based on its corresponding functional logic file and function associated resources. The functional logic file may be understood as a script file including control logic for the target function. In short, the functional logic file is a control logic script for the target function. When the target function is triggered, the target function is implemented by executing the functional logic file. Specifically, the target function is implemented by means of the invoked target object in the functional logic file. For example, the target object may include at least one of objects such as a function object, a class object, a variable object, and a constant object. The function associated resources may specifically include resources that need to be used during execution of the functional logic file, for example, at least one of resources such as mapping resources, text resources, and sound effect resources.

Specifically, parsing the functional logic file to obtain the target object corresponding to the target function may include: obtaining a functional object in the functional logic file that matches a regular expression corresponding to the functional logic file as the target object corresponding to the target function. With the present technical solution, the target object corresponding to the target function can be determined in a simple, fast, effective, and precise manner.

It can be understood that when a computer programming language used for the functional logic file is determined, the regular expression corresponding to the functional logic file can be determined based on a syntax corresponding to the computer programming language.

In embodiments of the present disclosure, there may be one or more regular expressions corresponding to the functional logic file. The number of regular expressions corresponding to the functional logic file is related to the syntax used by the functional logic file. When there are multiple regular expressions corresponding to the functional logic file, the multiple regular expressions generally correspond to different levels, and therefore, matching needs to be performed level by level to obtain the target object corresponding to the target function.

Optionally, when there is one regular expression corresponding to the functional logic file, the functional object in the functional logic file that matches the regular expression is used as the target object corresponding to the target function.

As described above, when there are multiple regular expressions corresponding to the functional logic file, matching needs to be performed level by level using regular expressions corresponding to all levels. Specifically, when there are multiple regular expressions corresponding to the functional logic file, a hierarchical relationship of the regular expressions is determined, and the functional object in the functional logic file that matches the regular expression of the last level is used as the target object corresponding to the target function. With the present technical solution, an in-depth analysis can be performed on the functional logic file, so that specific functional objects used in the functional logic file can be obtained, to provide effective data support for the precise pruning of the original entry file.

At S120, an original entry file corresponding to the target function and an object hierarchical relationship corresponding to the original entry file are obtained.

The original entry file includes a file index corresponding to each functional module in the function library corresponding to the target function. For example, the file index may be storage path information corresponding to the functional module. In some scenarios, the original entry file is also referred to as an index file. The function library may be understood as a tool library for storing functional modules. The functional module may be understood as a code module for implementing a preset function. In embodiments of the present disclosure, the functional module may be a basic capability module or a general capability module required in a function building process. For example, the functional module may be at least one of modules such as a time module, a logarithmic module, a mathematical function module, and a constant module. The functional module includes at least one functional object. For example, the functional object may include at least one of a function object, a class object, a variable object, and a constant object. Optionally, a packaged functional module is stored in the function library to allow reuse of the functional module, which reduces the time of repeated writing of the functional module, thus reducing time and effort and improving the development efficiency.

In embodiments of the present disclosure, the object hierarchical relationship is used to indicate an association relationship between each functional module in the function library corresponding to the target function and each functional object in the functional module. For example, the object hierarchical relationship may be stored in a tree structure or a table form. Each level in the object hierarchical relationship represents a hierarchical relationship between the functional module in the function library and the functional object. As an example, in a case of a tree structure of the object hierarchical relationship, with the function library as a root node and each functional module as a first-level leaf node of a different branch of the root node, leaf nodes of the functional modules, i.e., second-level leaf nodes, leaf nodes of the second-level leaf nodes, etc., may be determined in accordance with a dependency relationship between the functional modules and the functional objects, so that the tree structure of the object hierarchical relationship can be constructed. For example, the first-level leaf node of the function library used as the root node may be a time module, and the leaf nodes of the time module, i.e., the second-level leaf nodes, may be exported objects of the time module.

Specifically, by obtaining the original entry file corresponding to the target function, the reference to any functional module in the function library can be supported, and then, by obtaining the object hierarchical relationship corresponding to the original entry file, the association relationship between each functional module in the function library and the functional object can be intuitively learned, so as to provide information support for the subsequent optimization of the original entry file.

At S130, a target entry file corresponding to the target function is determined based on the object hierarchical relationship, the target object, and the original entry file.

Optionally, the original entry file is adjusted based on the object hierarchical relationship and the target object to obtain the target entry file corresponding to the target function. Specifically, content in the original entry file may be pruned based on the object hierarchical relationship and the target object to obtain the target entry file corresponding to the target function.

For example, when the original entry file is a script file, the content in the original entry file may be an execution statement in the script.

Specifically, a functional module associated with the target object is determined based on the object hierarchical relationship, and content in the original entry file that contains the target object and its associated functional modules are retained and the other content is deleted, thereby obtaining the target entry file corresponding to the target function. Text filtering is performed on functional logic scripts in the target function before the formal execution of the target function, to determine which target objects in the functional modules are to be used by the filtering, and then targeted elimination of functional modules is performed, and only the used functional modules are retained so as to cut down functional modules in the original entry file.

Since the target entry file no longer contains import modules for the functional modules that are not related to the target objects, the functional modules in the function library will not be loaded even if they have not been deleted. Thus, it is possible to ensure that the target object in the functional logic file can be successfully referenced and also reduce the loading of other functional modules, without changing the functional modules in the function library, thereby reducing time and spatial resources.

With the present technical solution, the content in the original entry file that is not related to the functional logic file can be pruned in an effective and precise manner and content related to the functional logic file is retained, so as to reduce the loading of unnecessary functional modules, which solves the technical problem of low functional response efficiency, reduces the response time of the target function, and improves the response efficiency of the target function, while ensuring the smooth execution of the functional logic file.

Optionally, target file content is obtained from the original entry file based on the object hierarchical relationship and the target object, and the target entry file corresponding to the target function is generated based on the target file content. Specifically, obtaining target file content from the original entry file based on the object hierarchical relationship and the target object may include: determining an associated object corresponding to the target object based on the object hierarchical relationship and the target object; and obtaining content associated with the associated object and the target object from the original entry file as the target file content. With the present technical solution, the original entry file can be retained while generating the target entry file, so as to support reuse of the original entry file, and when there is a problem with the target entry file, the original entry file may be used to perform the target function.

On the basis of any of the optional technical solutions of the embodiments of the present disclosure, after the obtaining the target entry file corresponding to the target function, the method may further include: invoking a functional module in the function library via the target entry file during execution of the functional logic file. With the present technical solution, only the functional modules in the function library that are to be referenced by the functional logic file can be loaded during loading of the functional modules corresponding to the target entry file, thus avoiding the waste of spatial resources and time brought about by the full loading of functional modules, thereby effectively improving the response efficiency of the target function.

In the technical solution of the embodiments of the present disclosure, by obtaining the functional logic file corresponding to the target function and parsing the functional logic file to obtain the target object corresponding to the target function, the target object associated with control logic for the target function can be effectively parsed, thereby providing a basis for pruning the original entry file; then, by obtaining the original entry file corresponding to the target function and the object hierarchical relationship corresponding to the original entry file, the association relationship between each functional module in the function library corresponding to the target function and each functional object in the functional module is teased out; and finally, by pruning content in the original entry file based on the object hierarchical relationship and the target object to obtain the target entry file corresponding to the target function, and by determining the target entry file corresponding to the target function based on the object hierarchical relationship, the target object, and the original entry file, the target entry file can be made to correspond to the functional logic file by adjusting the original entry file through the functional logic file, which solves the technical problem of low functional response efficiency caused by the use of the original entry file, reduces the response time of the target function, and improves the response efficiency of the target function, while ensuring the smooth execution of the functional logic file.

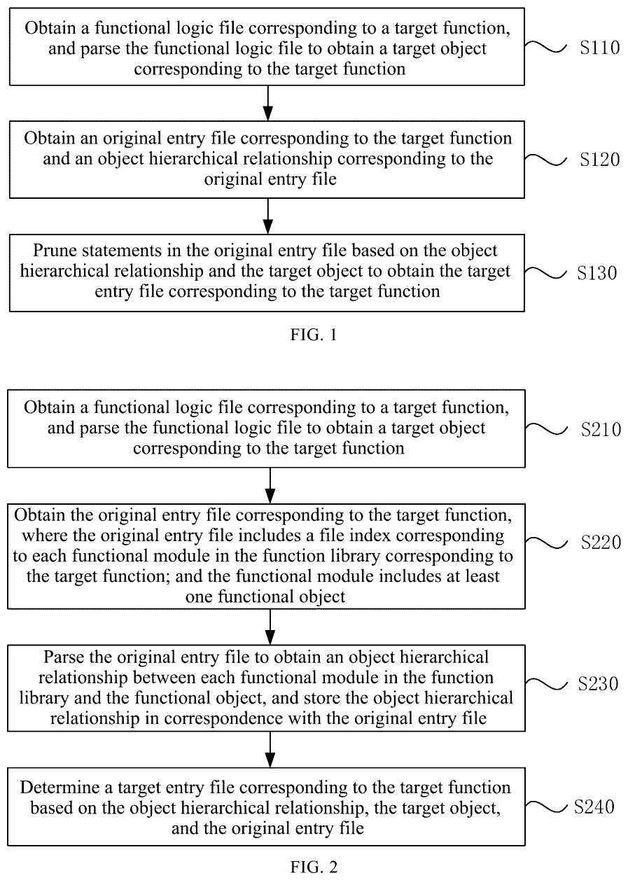

FIG. 2 is a schematic flowchart of another file processing method according to an embodiment of the present disclosure. The technical solution of this embodiment further refines, on the basis of the above embodiment, the process of obtaining the object hierarchical relationship. Optionally, the original entry file corresponding to the target function is obtained, where the original entry file includes a file index corresponding to each functional module in the function library corresponding to the target function, the functional module includes at least one functional object, and the functional object includes at least one of a function object, a class object, a variable object, and a constant object. The original entry file is parsed to obtain an object hierarchical relationship between each functional module in the function library and the functional object, and the object hierarchical relationship is stored in correspondence with the original entry file. For a specific implementation, reference can be made to the description of this embodiment. Technical features that are the same or similar to those in the preceding embodiments are not repeated herein.

As shown in FIG. 2, the method of this embodiment may specifically include the following steps.
At S210, a functional logic file corresponding to a target function is obtained, and the functional logic file is parsed to obtain a target object corresponding to the target function.
At S220, the original entry file corresponding to the target function is obtained, where the original entry file includes a file index corresponding to each functional module in the function library corresponding to the target function, and the functional module includes at least one functional object.

It is noted that the original entry file is associated with the function library. Different functions may correspond to the same function library or different function libraries. Then, the original entry files corresponding to different functions may be the same or different.

Optionally, obtaining the original entry file corresponding to the target function includes: editing an original entry file corresponding to the target function, or obtaining a pre-edited original entry file corresponding to the target function.

At S230, the original entry file is parsed to obtain an object hierarchical relationship between each functional module in the function library and the functional object, and the object hierarchical relationship is stored in correspondence with the original entry file.

Considering that the syntactic format of the original entry file is generally uniform, a method of filtering strings which is common to computer languages, i.e., regular expression, can be used, to filter multiple functional modules corresponding to the function library and functional objects contained in the functional modules from the entry file.

Specifically, parsing the original entry file to obtain the object hierarchical relationship between each functional module in the function library and the functional object may include: determining, based on a preset regular expression corresponding to the functional object of each level, the functional module or the functional object in the original entry file that corresponds to each level; and determining the object hierarchical relationship between each functional module in the function library and the functional object based on the functional object, the level corresponding to the functional object, and an association relationship between the levels. The use of the regular expression matching approach makes it possible to determine the functional modules and functional objects corresponding to the function library in a simple, fast and precise manner by means of the original entry file, and the association relationship between the levels characterizes the hierarchical relationship between the functional modules and the functional objects, making it possible to establish the object hierarchical relationship quickly.

Similar to the parsing of the original entry file, an expression corresponding to each level may be determined separately, and then the regular expression corresponding to each level may be used to perform matching level by level, so as to obtain functional modules and functional objects corresponding to the function library. Then, an association relationship between the functional modules and the functional objects is established according to the relationship between the levels, so as to obtain the object hierarchical relationship.

At S240, a target entry file corresponding to the target function is determined based on the object hierarchical relationship, the target object, and the original entry file.

In embodiments of the present disclosure, there are multiple ways of pruning the content in the original entry file based on the object hierarchical relationship and the target object. Optionally, a functional module associated with each target object may be determined based on the object hierarchical relationship as an associated module corresponding to the target object; and the content in the original entry file may be pruned based on the target object and the associated module. The present technical solution not only focuses on the target object itself involved in the functional logic file, but also can effectively determine the functional modules in the original entry file that are associated with the target object, thereby ensuring the data integrity of the target object and laying the foundation for the target object to be successfully executed even after the pruning of the original entry file.

Specifically, determining the functional module associated with each target object based on the object hierarchical relationship as the associated module corresponding to the target object includes: determining a functional module of a highest level that is associated with the target object based on the object hierarchical relationship as the associated module corresponding to the target object. Taking a tree structure as an example, queries can be performed level by level according to the object hierarchical relationship in a direction from the leaf node where the target object is located to the root node to determine the functional module associated with the target object that is closest to the root node, i.e., the functional module of the highest level. For example, the associated module contains a functional module for this target object and other functional modules having a dependency relationship with this target object, and so on. With the above technical solution, the successful execution of the target object can be fully guaranteed, and the retaining in units of functional modules can enhance the efficiency of subsequent content pruning of the original entry file.

Optionally, the pruning the content in the original entry file based on the target object and the associated module includes: retaining content in the original entry file that corresponds to the associated module and deleting the other content in the original entry file. For example, the content with keywords corresponding to the associated module for the target object and the content for loading the functional object of the time module may be obtained by the filtering first. Then, content with keywords corresponding to the target object is obtained by the filtering, for example, the content of the target object is exported. The content obtained by the filtering is then retained and the rest content is deleted. In this way, the original entry file is left with the functional modules in the functional logic file that are to be used and the specific exported target objects, and the rest is deleted. The number of loaded files of the function library when running the functional logic file is then greatly reduced, which makes the lagging problem optimized as well.

In the technical solution of the embodiment of the present disclosure, a file index corresponding to each functional module in the function library corresponding to the target function is recorded in the original entry file corresponding to the target function. Therefore, when the target function is used, it is possible to invoke the functional object in the functional module in the function library via the original entry file, thus ensuring a successful response of the target function. Then, by parsing the original entry file to obtain an object hierarchical relationship between each functional module in the function library and the functional object, it is possible to implement a refined analysis of the functional modules and functional objects in the function library, and by storing the object hierarchical relationship in correspondence with the original entry file, the functional modules and the functional objects are stored in a structured manner by means of the object hierarchical relationship, which provides a basis for subsequent content pruning of the original entry file.

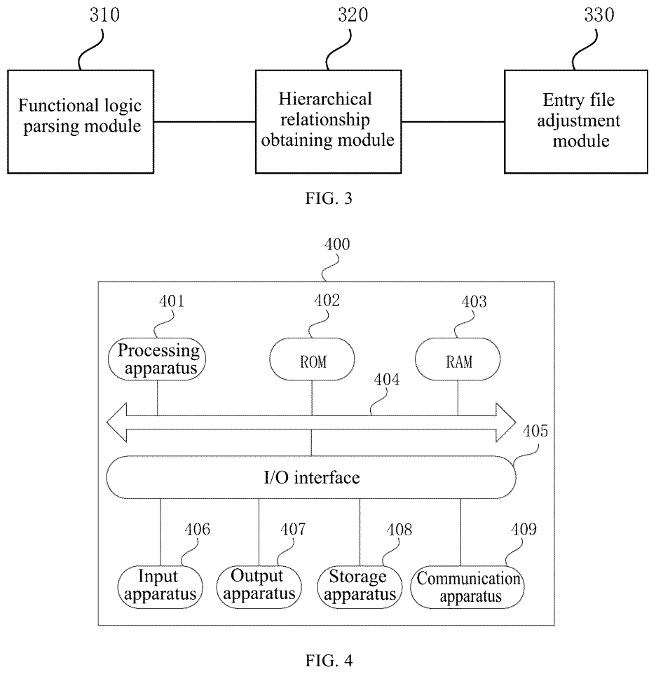

FIG. 3 is a schematic diagram of a structure of a file processing apparatus according to an embodiment of the present disclosure. As shown in FIG. 3, the file processing apparatus includes: a functional logic parsing module 310, a hierarchical relationship obtaining module 320, and an entry file adjustment module 330.

The functional logic parsing module 310 is configured to obtain a functional logic file corresponding to a target function, and parse the functional logic file to obtain a target object corresponding to the target function, where the functional logic file is a script file including control logic for the target function, and the target object includes at least one of a function object, a class object, a variable object, and a constant object. The hierarchical relationship obtaining module 320 is configured to obtain an original entry file corresponding to the target function and an object hierarchical relationship corresponding to the original entry file, where the object hierarchical relationship is used to indicate an association relationship between each functional module in a function library corresponding to the target function and each functional object in the functional module. The entry file adjustment module 330 is configured to determine a target entry file corresponding to the target function based on the object hierarchical relationship, the target object, and the original entry file.

In the technical solution of the embodiment of the present disclosure, by means of the functional logic parsing module obtaining the functional logic file corresponding to the target function and parsing the functional logic file to obtain the target object corresponding to the target function, the target object associated with control logic for the target function can be effectively parsed, thereby providing a basis for pruning the original entry file; then, by means of the hierarchical relationship obtaining module obtaining the original entry file corresponding to the target function and the object hierarchical relationship corresponding to the original entry file, the association relationship between each functional module in the function library corresponding to the target function and each functional object in the functional module is teased out; and finally, by means of the entry file adjustment module pruning content in the original entry file based on the object hierarchical relationship and the target object to obtain the target entry file corresponding to the target function, and by determining the target entry file corresponding to the target function based on the object hierarchical relationship, the target object, and the original entry file, the target entry file can be made to correspond to the functional logic file by adjusting the original entry file through the functional logic file, which solves the technical problem of low functional response efficiency caused by the use of the original entry file, reduces the response time of the target function, and improves the response efficiency of the target function, while ensuring the smooth execution of the functional logic file.

On the basis of any of the above optional technical solutions, optionally, the hierarchical relationship obtaining module 320 includes an original entry file obtaining unit and a hierarchical relationship parsing unit. The original entry file obtaining unit is configured to obtain the original entry file corresponding to the target function, where the original entry file includes a file index corresponding to each functional module in the function library corresponding to the target function, the functional module includes at least one functional object, the functional object including at least one of a function object, a class object, a variable object, and a constant object. The hierarchical relationship parsing unit is configured to parse the original entry file to obtain an object hierarchical relationship between each functional module in the function library and the functional object, and store the object hierarchical relationship in correspondence with the original entry file.

On the basis of any of the above optional technical solutions, optionally, the hierarchical relationship parsing unit includes: a file level-by-level parsing subunit and an association relationship determination subunit. The file level-by-level parsing subunit is configured to determine, based on a preset regular expression corresponding to the functional object of each level, the functional module or the functional object in the original entry file that corresponds to each level. The association relationship determination subunit is configured to determine the object hierarchical relationship between each functional module in the function library and the functional object based on the functional object, the level corresponding to the functional object, and an association relationship between the levels.

On the basis of any of the above optional technical solutions, optionally, the entry file adjustment module 330 includes: an entry file pruning module and a file content obtaining module. The entry file pruning module is configured to prune content in the original entry file based on the object hierarchical relationship and the target object to obtain the target entry file corresponding to the target function. Alternatively, the file content obtaining module is used for an entry file extraction module and is configured to obtain target file content from the original entry file based on the object hierarchical relationship and the target object, and generate the target entry file corresponding to the target function based on the target file content.

On the basis of any of the above optional technical solutions, optionally, the entry file pruning module includes: an associated module determination subunit and a file content pruning subunit. The associated module determination subunit is configured to determine a functional module associated with each target object based on the object hierarchical relationship as an associated module corresponding to the target object. The file content pruning subunit configured to prune the content in the original entry file based on the target object and the associated module.

On the basis of any of the above optional technical solutions, optionally, the associated module determination subunit is specifically configured to: determine a functional module of a highest level that is associated with the target object based on the object hierarchical relationship as the associated module corresponding to the target object.

On the basis of any of the above optional technical solutions, optionally, the file content pruning subunit is specifically configured to: retain content in the original entry file that corresponds to the associated module and delete the other content in the original entry file.

On the basis of any of the above optional technical solutions, optionally, the functional logic parsing module 310 is configured to: obtain a functional object in the functional logic file that matches a regular expression corresponding to the functional logic file as the target object corresponding to the target function.

On the basis of any of the above optional technical solutions, optionally, the functional logic parsing module 310 is specifically configured to: in response to existing multiple regular expressions corresponding to the functional logic file, determine a hierarchical relationship of the regular expressions, and use the functional object in the functional logic file that matches the regular expression of the last level as the target object corresponding to the target function.

On the basis of any of the above optional technical solutions, optionally, the file processing apparatus further includes: a functional logic file execution module. The functional logic file execution module is configured to invoke a functional module in the function library via the target entry file during execution of the functional logic file, after the obtaining of the target entry file corresponding to the target function.

The file processing apparatus according to an embodiment of the present disclosure can perform the file processing method according to any one of the embodiments of the present disclosure, and has corresponding functional modules and beneficial effects for performing the method.

It is worth noting that the units and modules included in the above apparatus are obtained through division merely according to functional logic, but are not limited to the above division, as long as corresponding functions can be implemented. In addition, specific names of the functional units are merely used for mutual distinguishing, and are not used to limit the protection scope of the embodiments of the present disclosure.

FIG. 4 is a schematic diagram of a structure of an electronic device according to an embodiment of the present disclosure. With reference to FIG. 4 below, a schematic diagram of a structure of an electronic device (e.g., a terminal device or a server in FIG. 4) 400 suitable for implementing embodiments of the present disclosure is illustrated. The terminal device in the embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 4 is merely an example, and shall not impose any limitation on the function and scope of use of the embodiments of the present disclosure.

As shown in FIG. 4, the electronic device 400 may include a processing apparatus (e.g., a central processing unit or a graphics processing unit) 401 that may perform a variety of appropriate actions and processing in accordance with a program stored in a read-only memory (ROM) 402 or a program loaded from a storage apparatus 408 into a random access memory (RAM) 403. The RAM 403 further stores various programs and data required for the operation of the electronic device 400. The processing apparatus 401, the ROM 402, and the RAM 403 are connected to each other through a bus 404. An input/output (I/O) interface 405 is also connected to the bus 404.

Generally, the following apparatuses may be connected to the I/O interface 405: an input apparatus 406 including, for example, a touchscreen, a touchpad, a keyboard, a mouse, a camera, a microphone, an accelerometer, and a gyroscope; an output apparatus 407 including, for example, a liquid crystal display (LCD), a speaker, and a vibrator; the storage apparatus 408 including, for example, a tape and a hard disk; and a communication apparatus 409. The communication apparatus 409 may allow the electronic device 400 to perform wireless or wired communication with other devices to exchange data. Although FIG. 4 shows the electronic device 400 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 409 and installed, installed from the storage apparatus 408, or installed from the ROM 402. When the computer program is executed by the processing apparatus 401, the above-mentioned functions defined in the method of the embodiment of the present disclosure are performed.

The names of messages or information exchanged between a plurality of apparatuses in the implementations of the present disclosure are used for illustrative purposes only, and are not used to limit the scope of these messages or information.

The electronic device according to an embodiment of the present disclosure and the file processing method according to the above embodiments belong to the same inventive concept. For the technical details not exhaustively described in this embodiment, reference may be made to the above embodiments, and this embodiment and the above embodiments have the same beneficial effects.

An embodiment of the present disclosure provides a computer storage medium storing a computer program thereon, where the program, when executed by a processor, implements the file processing method according to the above embodiments.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the HyperText Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: obtain a functional logic file corresponding to a target function, and parse the functional logic file to obtain a target object corresponding to the target function, where the functional logic file is a script file including control logic for the target function; and the target object includes at least one of a function object, a class object, a variable object, and a constant object; obtain an original entry file corresponding to the target function and an object hierarchical relationship corresponding to the original entry file, where the object hierarchical relationship is used to indicate an association relationship between each functional module in a function library corresponding to the target function and each functional object in the functional module; and determine a target entry file corresponding to the target function based on the object hierarchical relationship, the target object, and the original entry file.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two Internet Protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

According to one or more embodiments of the present disclosure, [Example 1] provides a file processing method, including: obtaining a functional logic file corresponding to a target function, and parsing the functional logic file to obtain a target object corresponding to the target function, where the functional logic file is a script file including control logic for the target function, the target object includes at least one of a function object, a class object, a variable object, and a constant object; obtaining an original entry file corresponding to the target function and an object hierarchical relationship corresponding to the original entry file, where the object hierarchical relationship is used to indicate an association relationship between each functional module in a function library corresponding to the target function and each functional object in the functional module; and determining a target entry file corresponding to the target function based on the object hierarchical relationship, the target object, and the original entry file.

According to one or more embodiments of the present disclosure, [Example 2] provides the method of Example 1, further including that: optionally, obtaining the original entry file corresponding to the target function and the object hierarchical relationship corresponding to the original entry file includes: obtaining the original entry file corresponding to the target function, where the original entry file includes a file index corresponding to each functional module in the function library corresponding to the target function, the functional module includes at least one functional object, and the functional object includes at least one of a function object, a class object, a variable object, and a constant object; and parsing the original entry file to obtain an object hierarchical relationship between each functional module in the function library and the functional object, and storing the object hierarchical relationship in correspondence with the original entry file.

According to one or more embodiments of the present disclosure, [Example 3] provides the method of Example 2, further including that: optionally, parsing the original entry file to obtain the object hierarchical relationship between each functional module in the function library and the functional object includes: determining, based on a preset regular expression corresponding to the functional object of each level, the functional module or the functional object in the original entry file that corresponds to each level; and determining the object hierarchical relationship between each functional module in the function library and the functional object based on the functional object, the level corresponding to the functional object, and an association relationship between the levels.

According to one or more embodiments of the present disclosure, [Example 4] provides the method of Example 1 or Example 2, further including that: optionally, determining the target entry file corresponding to the target function based on the object hierarchical relationship, the target object, and the original entry file includes: pruning content in the original entry file based on the object hierarchical relationship and the target object to obtain the target entry file corresponding to the target function; or obtaining target file content from the original entry file based on the object hierarchical relationship and the target object, and generating the target entry file corresponding to the target function based on the target file content.

According to one or more embodiments of the present disclosure, [Example 5] provides the method of Example 4, further including that: optionally, pruning content in the original entry file based on the object hierarchical relationship and the target object includes: determining a functional module associated with each target object based on the object hierarchical relationship as an associated module corresponding to the target object; and pruning the content in the original entry file based on the target object and the associated module.

According to one or more embodiments of the present disclosure, [Example 6] provides the method of Example 5, further including that: optionally, determining the functional module associated with each target object based on the object hierarchical relationship as the associated module corresponding to the target object includes: determining a functional module of a highest level that is associated with the target object based on the object hierarchical relationship as the associated module corresponding to the target object.

According to one or more embodiments of the present disclosure, [Example 7] provides the method of Example 5, further including that: optionally, pruning the content in the original entry file based on the target object and the associated module includes: retaining content in the original entry file that corresponds to the associated module and deleting the other content in the original entry file.

According to one or more embodiments of the present disclosure, [Example 8] provides the method of Example 1, further including that: optionally, parsing the functional logic file to obtain the target object corresponding to the target function includes: obtaining a functional object in the functional logic file that matches a regular expression corresponding to the functional logic file as the target object corresponding to the target function.

According to one or more embodiments of the present disclosure, [Example 9] provides the method of Example 8, further including that: optionally, obtaining the functional object in the functional logic file that matches the regular expression corresponding to the functional logic file as the target object corresponding to the target function includes: in response to existing multiple regular expressions corresponding to the functional logic file, determining a hierarchical relationship of the regular expressions, and using the functional object in the functional logic file that matches the regular expression of a last level as the target object corresponding to the target function.

According to one or more embodiments of the present disclosure, [Example 10] provides the method of Example 1, further including that: optionally, after the obtaining the target entry file corresponding to the target function, the method further includes: invoking a functional module in the function library via the target entry file during execution of the functional logic file.

According to one or more embodiments of the present disclosure, [Example 11] provides a file processing apparatus, including: a functional logic parsing module configured to obtain a functional logic file corresponding to a target function, and parse the functional logic file to obtain a target object corresponding to the target function, where the functional logic file is a script file including control logic for the target function, the target object includes at least one of a function object, a class object, a variable object, and a constant object; a hierarchical relationship obtaining module configured to obtain an original entry file corresponding to the target function and an object hierarchical relationship corresponding to the original entry file, where the object hierarchical relationship is used to indicate an association relationship between each functional module in a function library corresponding to the target function and each functional object in the functional module; and an entry file adjustment module configured to determine a target entry file corresponding to the target function based on the object hierarchical relationship, the target object, and the original entry file.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

I/we claim:

1. A file processing method, comprising:
obtaining a functional logic file corresponding to a target function, and parsing the functional logic file to obtain a target object corresponding to the target function, wherein the functional logic file is a script file comprising control logic for the target function, and the target object comprises at least one of a function object, a class object, a variable object, and a constant object;
obtaining an original entry file corresponding to the target function and an object hierarchical relationship corresponding to the original entry file, wherein the object hierarchical relationship is used to indicate an association relationship between each functional module in a function library corresponding to the target function and each functional object in the functional module; and
determining a target entry file corresponding to the target function based on the object hierarchical relationship, the target object, and the original entry file.

2. The file processing method according to claim 1, wherein obtaining the original entry file corresponding to the target function and the object hierarchical relationship corresponding to the original entry file comprises:
obtaining the original entry file corresponding to the target function, wherein the original entry file comprises a file index corresponding to each functional module in the function library corresponding to the target function, the functional module comprises at least one functional object, and the functional object comprises at least one of a function object, a class object, a variable object, and a constant object; and
parsing the original entry file to obtain the object hierarchical relationship between each functional module in the function library and the functional object, and storing the object hierarchical relationship in correspondence with the original entry file.

3. The file processing method according to claim 2, wherein parsing the original entry file to obtain the object hierarchical relationship between each functional module in the function library and the functional object comprises:
determining, based on a preset regular expression corresponding to the functional object of each level, the functional module or the functional object in the original entry file that corresponds to each level; and
determining the object hierarchical relationship between each functional module in the function library and the functional object based on the functional object, the level corresponding to the functional object, and an association relationship between the levels.

4. The file processing method according to claim 1, wherein determining the target entry file corresponding to the target function based on the object hierarchical relationship, the target object, and the original entry file comprises:
pruning content in the original entry file based on the object hierarchical relationship and the target object to obtain the target entry file corresponding to the target function; or
obtaining target file content from the original entry file based on the object hierarchical relationship and the target object, and generating the target entry file corresponding to the target function based on the target file content.

5. The file processing method according to claim 4, wherein pruning content in the original entry file based on the object hierarchical relationship and the target object comprises:
determining a functional module associated with each target object based on the object hierarchical relationship as an associated module corresponding to the target object; and
pruning the content in the original entry file based on the target object and the associated module.

6. The file processing method according to claim 5, wherein determining the functional module associated with each target object based on the object hierarchical relationship as the associated module corresponding to the target object comprises:
determining a functional module of a highest level that is associated with the target object, based on the object hierarchical relationship, as the associated module corresponding to the target object.

7. The file processing method according to claim 5, wherein pruning the content in the original entry file based on the target object and the associated module comprises:
retaining content in the original entry file that corresponds to the associated module, and deleting the other content in the original entry file.

8. The file processing method according to claim 1, wherein parsing the functional logic file to obtain the target object corresponding to the target function comprises:
obtaining a functional object in the functional logic file that matches a regular expression corresponding to the functional logic file as the target object corresponding to the target function.

9. The file processing method according to claim 8, wherein obtaining the functional object in the functional logic file that matches the regular expression corresponding to the functional logic file as the target object corresponding to the target function comprises:
in response to existing multiple regular expressions corresponding to the functional logic file, determining a hierarchical relationship of the regular expressions, and using a functional object in the functional logic file that matches a regular expression of a last level as the target object corresponding to the target function.

10. The file processing method according to claim 1, wherein after obtaining the target entry file corresponding to the target function, the method further comprises:
invoking a functional module in the function library via the target entry file during execution of the functional logic file.

11. An electronic device, comprising:
one or more processors; and
a storage apparatus configured to store one or more programs,
wherein the one or more programs, when executed by the one or more processors, cause the one or more processors to:
obtain a functional logic file corresponding to a target function, and parse the functional logic file to obtain a target object corresponding to the target function, wherein the functional logic file is a script file comprising control logic for the target function, and the target object comprises at least one of a function object, a class object, a variable object, and a constant object;
obtain an original entry file corresponding to the target function and an object hierarchical relationship corresponding to the original entry file, wherein the object hierarchical relationship is used to indicate an association relationship between each functional module in a function library corresponding to the target function and each functional object in the functional module; and
determine a target entry file corresponding to the target function based on the object hierarchical relationship, the target object, and the original entry file.

12. The electronic device according to claim 11, wherein to obtain the original entry file corresponding to the target function and the object hierarchical relationship corresponding to the original entry file, the one or more programs cause the one or more processors to:
obtain the original entry file corresponding to the target function, wherein the original entry file comprises a file index corresponding to each functional module in the function library corresponding to the target function, the functional module comprises at least one functional object, and the functional object comprises at least one of a function object, a class object, a variable object, and a constant object; and
parse the original entry file to obtain the object hierarchical relationship between each functional module in the function library and the functional object, and store the object hierarchical relationship in correspondence with the original entry file.

13. The electronic device according to claim 12, wherein to parse the original entry file to obtain the object hierarchical relationship between each functional module in the function library and the functional object, the one or more programs cause the one or more processors to:
determine, based on a preset regular expression corresponding to the functional object of each level, the functional module or the functional object in the original entry file that corresponds to each level; and
determine the object hierarchical relationship between each functional module in the function library and the functional object based on the functional object, the level corresponding to the functional object, and an association relationship between the levels.

14. The electronic device according to claim 11, wherein to determine the target entry file corresponding to the target function based on the object hierarchical relationship, the target object, and the original entry file, the one or more programs cause the one or more processors to:
prune content in the original entry file based on the object hierarchical relationship and the target object to obtain the target entry file corresponding to the target function; or
obtain target file content from the original entry file based on the object hierarchical relationship and the target object, and generate the target entry file corresponding to the target function based on the target file content.

15. The electronic device according to claim 14, wherein to prune content in the original entry file based on the object hierarchical relationship and the target object, the one or more programs cause the one or more processors to:
determine a functional module associated with each target object based on the object hierarchical relationship as an associated module corresponding to the target object; and
prune the content in the original entry file based on the target object and the associated module.

16. The electronic device according to claim 15, wherein to determine the functional module associated with each target object based on the object hierarchical relationship as the associated module corresponding to the target object, the one or more programs cause the one or more processors to:
determine a functional module of a highest level that is associated with the target object, based on the object hierarchical relationship, as the associated module corresponding to the target object.

17. The electronic device according to claim 15, wherein to prune the content in the original entry file based on the target object and the associated module, the one or more programs cause the one or more processors to:
retain content in the original entry file that corresponds to the associated module, and delete the other content in the original entry file.

18. The electronic device according to claim 11, wherein to parse the functional logic file to obtain the target object corresponding to the target function, the one or more programs cause the one or more processors to:
obtain a functional object in the functional logic file that matches a regular expression corresponding to the functional logic file as the target object corresponding to the target function.

19. The electronic device according to claim 18, wherein to obtain the functional object in the functional logic file that matches the regular expression corresponding to the functional logic file as the target object corresponding to the target function, the one or more programs cause the one or more processors to:
in response to existing multiple regular expressions corresponding to the functional logic file, determine a hierarchical relationship of the regular expressions, and use a functional object in the functional logic file that matches a regular expression of a last level as the target object corresponding to the target function.

20. A non-transitory storage medium comprising computer-executable instructions, wherein the computer-executable instructions, when executed by a computer processor, are configured to:
obtain a functional logic file corresponding to a target function, and parse the functional logic file to obtain a target object corresponding to the target function, wherein the functional logic file is a script file comprising control logic for the target function, and the target object comprises at least one of a function object, a class object, a variable object, and a constant object;
obtain an original entry file corresponding to the target function and an object hierarchical relationship corresponding to the original entry file, wherein the object hierarchical relationship is used to indicate an association relationship between each functional module in a function library corresponding to the target function and each functional object in the functional module; and
determine a target entry file corresponding to the target function based on the object hierarchical relationship, the target object, and the original entry file.
